(19) United States
(12) Patent Application Publication
(10) Pub. No.: US 2012/0181784 A1
(43) Pub. Date: Jul. 19, 2012

(54) Business Card With Miniature Gift Cards And Method of Use

(76) Inventor: Roger E. Kraft, Fort Scott, KS (US)

(21) Appl. No.: 13/354,069

(22) Filed: Jan. 19, 2012

Related U.S. Application Data
(60) Provisional application No. 61/434,125, filed on Jan. 19, 2011.

(51) Int. Cl. B42D 15/00

(52) U.S. Cl. 283/56

(57) ABSTRACT

A business card is constructed with dimensions of 2 inches wide and 3 inches long. Miniature gift or promotional cards are detachably secured to the border or edges of the business card by tabs. The miniature gift or promotional cards may be separated from the business card by a customer or potential customer and submitted to the business identified on the card to receive a gift, discount, rebate, or cash at the time the customer purchases goods for services from the business identified on the card. Methods of making and using the business cards are also provided.

### RELATED APPLICATION

This application claim priority to U.S. Patent Application Ser. No. 61/434,125, filed Jan. 19, 2012 the disclosure of which is incorporated herein by reference.

### FIELD OF INVENTION

The field of the invention is business cards with attached miniature gift or benefit cards.

### BACKGROUND

Business cards are in common use. A person representing a business commonly carries business cards that contain information about the card carrier and the business he or she represents. The business cards may be given to potential or actual customers of the business. The customer uses the information on the card to contact and communicate with the card carrier when the customer wants to do business with the card carrier or his or her business.

Most business cards are rectangular in shape and are two inches high and three inches long. The size of business cards distinguishes them from gift cards, credit cards, discount cards, and loyalty cards, which are typically made of plastic and are 2⅛ inches high and 3⅜ inches long. In addition, most business cards are made of paper, which may be easily destroyed, bent, torn, or mutilated, and are not as impressive or prominent as credit cards, gift cards, discount cards, and loyalty cards.

### SUMMARY OF INVENTION

The invention comprises a plastic or laminate business card that is substantial and impressive in appearance while maintaining the common 2 inch by 3 inch size of business cards. Miniature gift or promotional cards are detachable secured to the business card. The miniature gift or promotional cards may be separated from the business card by the customer and submitted to the business identified on the card to receive a gift, discount, rebate, or cash at the time the customer purchases goods for services from the business identified on the card. The miniature gift or promotion cards may be attached to the business card in various patterns to make the card easy to store and use. The business card may also be made of other materials, including paper.

### BRIEF DESCRIPTION OF THE DRAWINGS

FIG. 1 shows an embodiment of a business card of the invention containing miniature gift or promotional cards attached at opposite ends of the card.

FIG. 2 shows an alternative embodiment of the business card of the invention containing miniature gift or promotional cards attached to the borders of the card.

FIG. 3 shows another alternative embodiment of the business card of the invention containing miniature gift or promotional cards attached to opposite sides of the card.

### DETAILED DESCRIPTION OF INVENTION

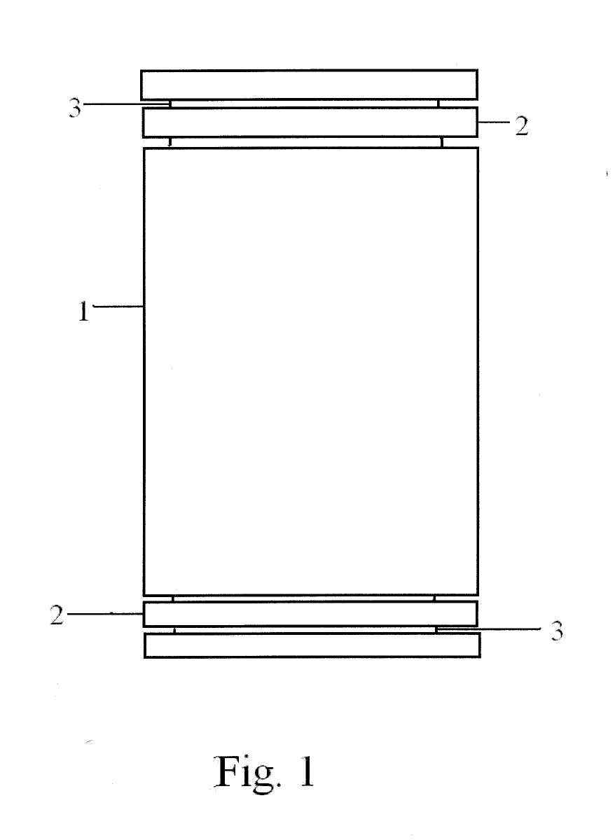

FIG. 1 shows a business card 1 with gift cards 2 attached by break-away tabs 3.

The dimensions of the card 1 are 2 inches by 3 inches, a standard business card size. The card 1 may be made of PVC (polyvinylchloride). Alternatively, the card 1 may have a composite construction comprising top and bottom plastic laminates with a printed sheet between the laminates. The card 1 may be 10, 20 or 30 millimeters thick using either type of material. The card 1 may also be made of other materials such as paper or any other material that allows the attachment and removal of the removal of miniature cards 2 therefrom.

The miniature gift cards 2 may be made of the same material as the card 1. The miniature cards 2 are connected to the card 1 by tabs 3. The card 1 and the miniature cards 2 may be made by die cutting a sheet of the PVC or laminate card material in a manner such that the tabs 3 are left after the die cutting operation.

FIG. 1 shows four gift cards 2 attached to the card 1. However, there could be one miniature card 2 attached to the card 1 or as many miniature cards 2 attached to the card 1 as desired within the limits of die cutting and the size of the miniature cards 2. The miniature cards 2 are shown in FIG. 1 as being on the ends of the card 1, however, the miniature cards 2 may also be attached along the top and/or the ends of the card 1, allowing numerous options as to the location, size, and number of the miniature cards 2 that are attached to the card 1.

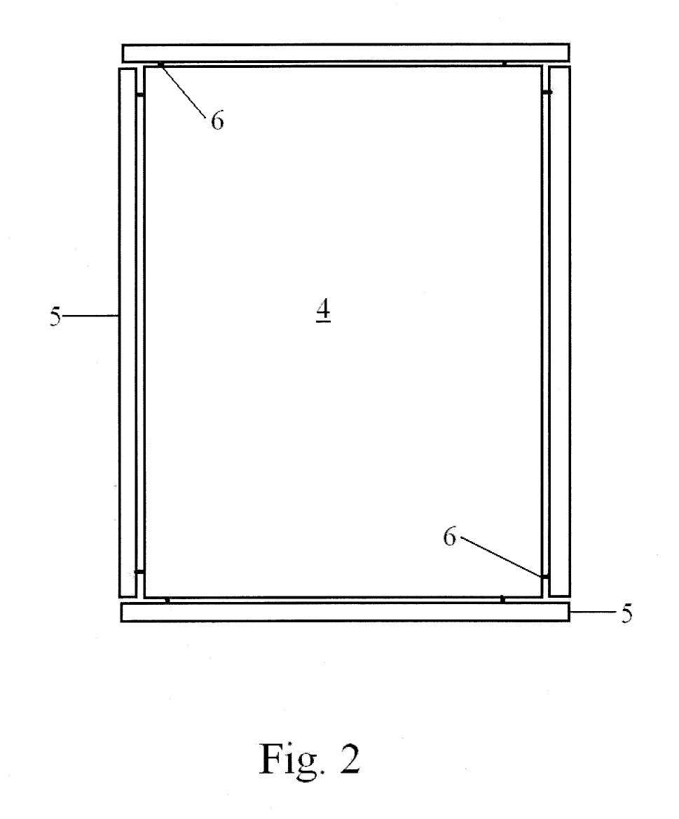

An alternative embodiment, business card 4, is shown in FIG. 2. The card 4 is the same size as shown in FIG. 1. The same options as to construction, thickness and the materials may be employed in making the card 4 as are available to make the card 1.

As shown in FIG. 2, miniature gift cards 5 are secured by tabs 6 to each of the four sides of the card 5. In this embodiment, the miniature cards 5 are narrower. If the card 4 is constructed with dimensions of 3 inches by 2 inches and the miniature cards 5 are constructed or die cut to have dimensions of ⅛ inch or 3/16 inch high, the overall construction will be very similar to that of a credit card or debit card, which is 2⅛ inches by 3⅜ inches. When the miniature cards 5 are removed and used, the card 4 will ultimately be the same size as a typical business card, which is 2 inches by 3 inches, and, as such, and may be kept by the customer with other cards.

The cards 1, 2, 4, and 5 contain printing and/or images of any desired nature. Cards 1 and 4, for example, may contain the name, address, telephone, and email information of the business to which it relates, as well as the name and contact information of the representative who carries the card. The miniature cards 2 and 5 may contain a dollar amount that may be redeemed upon purchase by the customer, or they may contain percentage discount information that the customer may use at the time of purchase of goods or services of the business identified on the card 1 or 4. In the alternative, the miniature cards 2 or 5 may contain information on premium goods such as jackets, t-shirts, caps, pens, or other items that the customer may receive from the business at the time of purchase. Of course, rebates or other customer incentives may also be specified on the miniature cards 2 or 5.

In use, the card 1 or card 4, with attached miniature cards 2 or 5, is carried by the representative of the business whose information is printed on the card 1 or 4. The representative of the business gives the card 1 or 4, with the attached miniature cards 2 or 5 to a customer or prospective customer. The customer or prospective customer keeps the card until goods or services are desired to be purchased from the business identified on the card 1 or 4. When the customer or potential customer purchases goods or services from the business identified on the card 1 or 4, the customer removes or detaches one of the gift cards and submits it to the business to secure the gift, discount, rebate, or goods from the business.

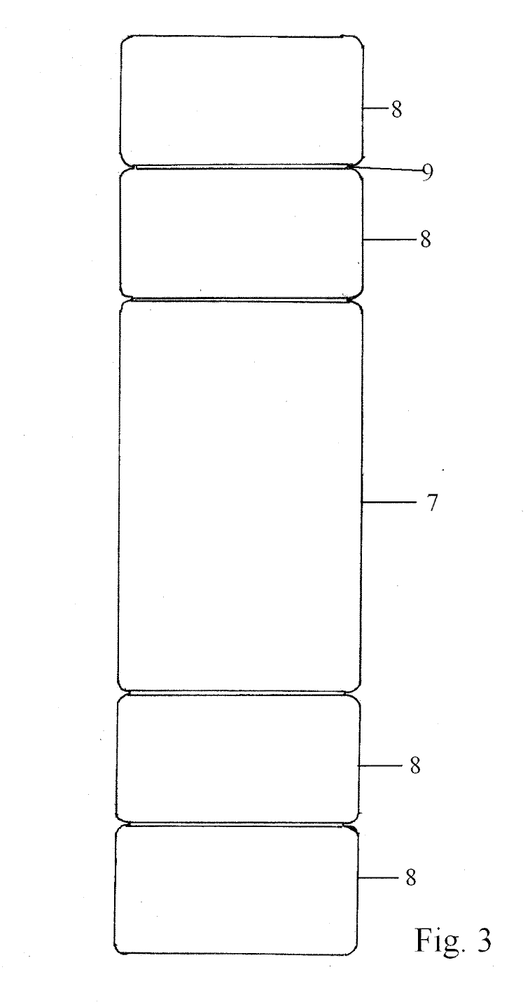

In another embodiment, shown in FIG. 3, the card and miniature card patterns are similar to those shown in FIG. 1. A card 7 is flanked by miniature cards 8, which are attached to the card 7 by tabs 9. The miniature cards 8 are larger in this embodiment than in the embodiment shown in FIG. 1, while the card 7 is the same size as the card 1 shown in FIG. 1. In the embodiment shown in FIG. 3, the miniature cards may contain more information and, if desired, may be removed and stored by the recipient of the card for future use in the manner described above.

The above disclosure is not intended to be limiting as to the size, materials, dimensions, nature of identification, gifts, rebates, or other incentives that may be provided by the business cards described about, nor is the above disclosure intended to be limiting as to the number of gift cards that may be attached to the business card 1 or 4. Any number of cards with any number of incentives may be secured to the cards 1 or 4; moreover, the miniature gift cards may be of one of more dimensions and locations on the cards 1 or 4.

It is claimed as follows:

1. A business card comprising:
(a) a card containing identification information for a business;
(b) at least one detachable miniature card secured to the business card by tabs
(c) the detachable miniature card containing information about a gift or other benefit;
whereby, the miniature card is detached from the card and submitted to the business to secure the gift or other benefit.

2. The business card of claim 1 wherein the card has dimensions of 3 inches by 2 inches.

3. The business card of claim 1 wherein the card is made of PVC.

4. The business card of claim 1 wherein the card comprises a laminate of plastic and paper.

5. The business card of claim 1 wherein the miniature cards are made of PVC.

6. The business card of claim 1 wherein the miniature cards comprise a laminate of plastic and paper.

7. The business card of claim 1 wherein at least one of the miniature cards contains information about at least one of a gift of money, a gift of goods, a discount, and a rebate.

8. A method of using a business card comprising:
(a) providing a business card to a customer, the business card containing identification information for a business, the business card having at least one miniature card detachably secured to the business card by tabs;
(b) allowing the customer to detach the miniature card from the business card and submit the miniature card to the business identified on the card;
(c) providing the customer with at least one of a discount, gift, rebate, and money upon submission of the miniature card to the business.

9. The method of claims 8 wherein the business card has dimension of 3 inches by 2 inches.

10. The method of claims 8 wherein the sheet of material is made of PVC.

11. The method of claims 8 wherein the sheet material has a thickness of at least one of 10, 20, or 30 millimeters.

12. The method of claims 8 wherein the sheet material is a laminate of paper and plastic.

13. A method of making a business card comprising:
(a) providing a sheet of material containing information identifying a business and information identifying at least one of a gift, discount, rebate and an amount of money;
(b) die cutting the sheet to provide a business card containing the business identification information and at least one miniature card detachably secured to the business card, the miniature card identifying at least one of a gift, discount, rebate and an amount of money;

14. The method of claims 13 wherein the business card has dimension of 3 inches by 2 inches.

15. The method of claims 13 wherein the sheet of material is made of PVC.

16. The method of claims 13 wherein the sheet material has a thickness of at least one of 10, 20, or 30 millimeters.

17. The method of claims 13 wherein the sheet material is a laminate of paper and plastic.
